(19) United States
(12) Patent Application Publication
(10) Pub. No.: US 2012/0324792 A1
(43) Pub. Date: Dec. 27, 2012

(54) SAFETY GATE

(75) Inventors: Michel BERTSCH, Gaaden-Oesterreich (BE); Michael Verleyen, Liege (BE)

(73) Assignee: Indowoods S.A.

(21) Appl. No.: 13/602,693

(22) Filed: Sep. 4, 2012

Related U.S. Application Data
(63) Continuation of application No. PCT/EP2011/000866, filed on Feb. 23, 2011.

(30) Foreign Application Priority Data
Mar. 1, 2010 (DE) DE 102010009803.5
May 10, 2010 (EP) PCT/EP2010/002881

(51) Int. Cl. E06B 9/06; A47D 13/06

(52) U.S. Cl. 49/37; 49/57

(57) ABSTRACT

A safety gate, in particular for children or pets, is provided that includes a frame which can be stationarily positioned, the frame having a lower base and two side parts protruding upwards from the base, a door member being hinged to the frame, the door member being swivable about a pivot axis, and a lock, the door member and the frame being realeasably interconnectable with each other by means of the lock, wherein the lock comprises an actuation member for an at least partial releasing of the lock, wherein the actuation member is arranged stationarily at one of the side parts of the frame.

This nonprovisional application is a continuation of International Application No. PCT/EP2011/000866, which was filed on Feb. 23, 2011, and which claims priority to German Patent Application No. DE 102010009803.5 and PCT/EP2010/002881, which were on Mar. 1, 2010 and May 10, 2010, respectively, and which are all herein incorporated by reference.

### BACKGROUND OF THE INVENTION

1. Field of the Invention

The present invention relates to a safety gate, in particular for children or pets.

2. Description of the Background Art

From the conventional art, safety gates are known which can be set into door frames, passages, landings etc. in order to particularly prevent small children, eventually pets as well, from crossing. A lockable door is provided in the safety gate in order to allow for a most simple crossing by an adult.

### SUMMARY OF THE INVENTION

It is therefore an object of the present invention to provide a protection safety gate which is simply to operate by an adult.

In an embodiment, an arrangement of an actuation member at the stationary positioned frame enables for an uncomplicated operation of a stationary actuation member, wherein the actuation member is not held in hand when pivoting the door, other than in the case of actuation members positioned at the door. member. This enables for a better support during the lock opening and intuitively encourages a supplementary pushing open of the door member, e.g. by the foot or leg. In this way, the operation for users carrying objects is particularly simplified.

In an embodiment, a positive blockade against a pivoting of the door member is provided between the door member and the frame, wherein the blockade can be released by moving the door member about a defined stroke parallel to the pivot axis. In this way, the door member is double secured, as for the opening the actuation member has to be actuated first, in order to enable a successive moving or lifting of the door member along the pivot axis. Only by this movement, the door member is freed for opening or pivoting about the pivot axis. Generally, the blockade which is freed by the lifting may be arranged at the position of the locking member or be integrated therewith, or may be arranged separately therefrom, or may be arranged at the locking member as well as separated therefrom.

The door member can be pivoted open from the closed position in two directions, enabling for a particularly flexible application.

In an embodiment of the invention, the actuation member comprises a spring loaded slide for opening the lock with the effect of a simple operation. Advantageously, this slide can be moveable parallel to a plane which is stretched out by the frame.

For a simply provision of an improved securing, it is provided that an abutment being arranged at the door member can be overlapped by a moveable latch of the actuation member, wherein a lifting of the door member is blocked by the overlapping of the abutment. In a preferred development, the abutment can be formed as a horizontally protruding pointer, the pointer in particular being formed like a plate. Further advantageously, a catch member may be arranged at one of the group of actuation member and abutment, the catch member being spring loaded and in particularly being moveable in perpendicular direction, wherein a shackle member acting in combination with the catch member is arranged at the respective other from the group. When pushing the door closed, the catch can then snap into the shackle member. In this case, the snapped in catch member may advantageously also provide a positive blockade, which can be released by a lifting of the door, for instance after a release by pulling the actuation member backwards.

In an embodiment, a second lock can be provided between the door member and the frame. In a preferred development, the second lock is in particular arranged at the lower base, providing for a good rigidity of the closed door in the bottom region. In preferred detail development, the second lock can be released by means of moving the door member by a stroke parallel to the pivot axis. Such blockade being releasable by lifting the door may be provided either exclusively or additionally (as a second positive blockade) by the second lock.

For the purpose of a simple and secure closing procedure it is provided that, in the course of pivoting the door member into the closed position, the second lock snaps, in particular by means of a spring-loaded catch.

In the case of a possible embodiment of the invention, the frame can be dismantably fixed between stationary structures, for example door frames, walls or banisters. The fixation can be provided by means of jamming or bolting or by other means.

In an embodiment of the invention, the safety gate comprises one out of a plurality of segments of a foldable barrier. The barrier may be, for example, an enclosed, set-up playpen for a small child, or a barrier made up from several segments, which may be set up, for instance, in front of a fireplace. The further segments may be designed as rigid grids or panels which cannot be opened.

An articulated connection is provided between the segments, which connection being realeasably fixable in a positive controlled manner in multiple, discrete angular positions. Thereby, a particularly variable installation is achieved. In particular, one or more of the segments may be detachable.

The door member may be applied with a resetting force, for example by a spring action from a resetting hinge.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a spatial view of an inventive safety gate with a closed door member;

FIG. 2 shows the spatial detailed view of the safety gate from FIG. 1 with open door member;

FIG. 3 shows a plain view of the safety gate from FIG. 1 with all components displayed;

FIG. 4 to FIG. 7 show enlarged details of the display from FIG. 3;

FIG. 8 shows a display of the safety gate from FIG. 2 with a lock exploded into parts;

FIG. 9 shows a spatial view of a barrier with six segments;

FIG. 10 shows a barrier according to the invention with two segments;

FIG. 11 shows a spatial view of a connector of the barriers from FIG. 9 and FIG. 10;

FIG. 12 shows a terminal connector of the barrier of FIG. 10;

FIG. 13 shows a sectional view of an upper hinge of the barriers from FIG. 9 and FIG. 10 in an exploded and a mounted view;

FIG. 14 shows a partial, spatial view of the hinge from FIG. 13;

FIG. 14a shows a variation of a hinge part from a hinge from FIG. 13 for a lower hinge;

FIG. 15 shows several spatial, sometimes sectional views of a first hinge part of the hinge from FIG. 13; and

FIG. 16 shows a sectional view of the hinge from FIG. 13 in a locked (left side) and a released (right side) arrangement.

### DETAILED DESCRIPTION

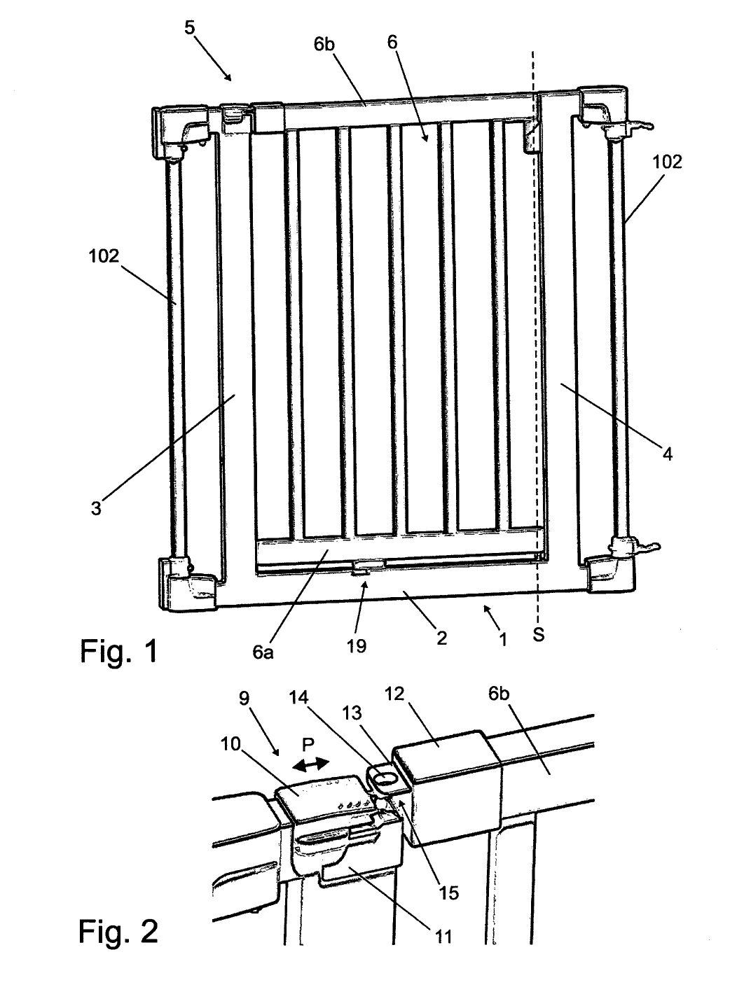

The safety gate shown in FIG. 1 comprises a lower frame 1, that has a lower base 2, a first, perpendicular side part 3 and a second, perpendicular side part 4. The safety gate is provided as a segment of a foldable barrier or safety gate, therefore articulated connections 102 being respectively provided at the side parts 3, 4 for the purpose of adjustably connecting further segments.

In an alternative embodiment not displayed, the frame 1 may be stationarily positioned for example in a door frame by means of jamming bolts arranged at each of the side parts 3, 4. In a known manner, the jamming bolts may interact with sockets (not displayed) screwed to the door frame. The jamming bolts may also be provided with optional extensions in an known manner, in order to adapt to over-wide door frames.

A door member 6 is pivotably received in the frame 1. This is done by means of an upper hinge 7 and a lower hinge 8. The upper hinge 7 is provided as a plastic-molded part and is fixed to an upper end of the second side part 4 on one side and to an upper crossbar of the door member 6 on the other side. The lower hinge 8 comprises a hinge pin 8a, which is accommodated in a base 2 of the frame 1 and protrudes into a borehole in a lower crossbar of the door member 6.

A pivot axis S of the door member 6 is defined as a connecting line of the two hinges 7, 8.

The upper hinge 7, see detail view in FIG. 5, has a door-sided first hinge half 7a, which is fixed to an upper crossbar 6b of the door member, and has a frame-sided second hinge half 7b. The hinge halves 71, 7b are interconnected to each other by means of a hinge pin 7c, wherein the hinge halves 7a, 7b are displacable to each other by a stroke H in the direction of the pivot axis S (hinge axis).

The hinge 7 is designed as a self-locking hinge, the hinge halves therefore interacting along inclined sliding faces 7d. When the door is pivoted from the locked or center position, the hinge halves 7a, 7b push each other away by their sliding faces 7d, the door member experiencing an upward stroke. Respectively, a resetting force directed downward along the pivot axis provides for a resulting torque for resetting the door member into the locking position.

The resetting is generated from the weight force of the door member as well as from a resetting spring 8b, which resetting spring here being arranged at the hinge pin 8a of the lower hinge and/or is supported between door member 6 and hinge pin 8a. FIG. 7 shows the lower hinge 8 in a position with the door member 6 being lifted by the stroke H and the spring 8b being fully loaded.

For realeasable interconnection of the door member 6 at the frame 1 in a closed or pivoted closed position, a lock 5 is provided. The lock 5 is arranged in the upper region of the safety gate at the first side part 3 and the adjacent end of the upper crossbar, which end being opposite to the hinge 7.

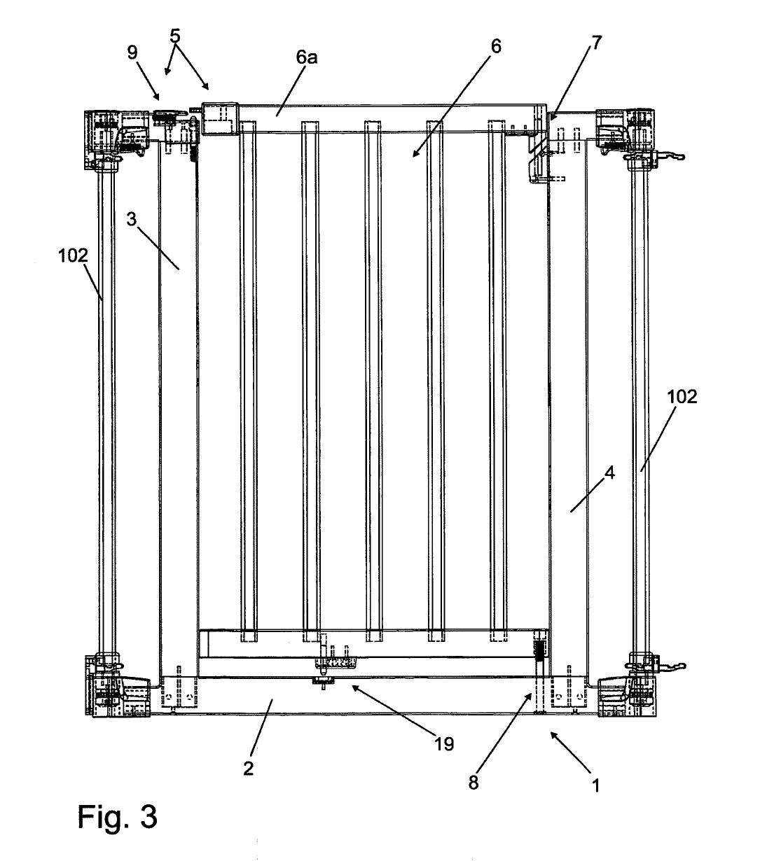

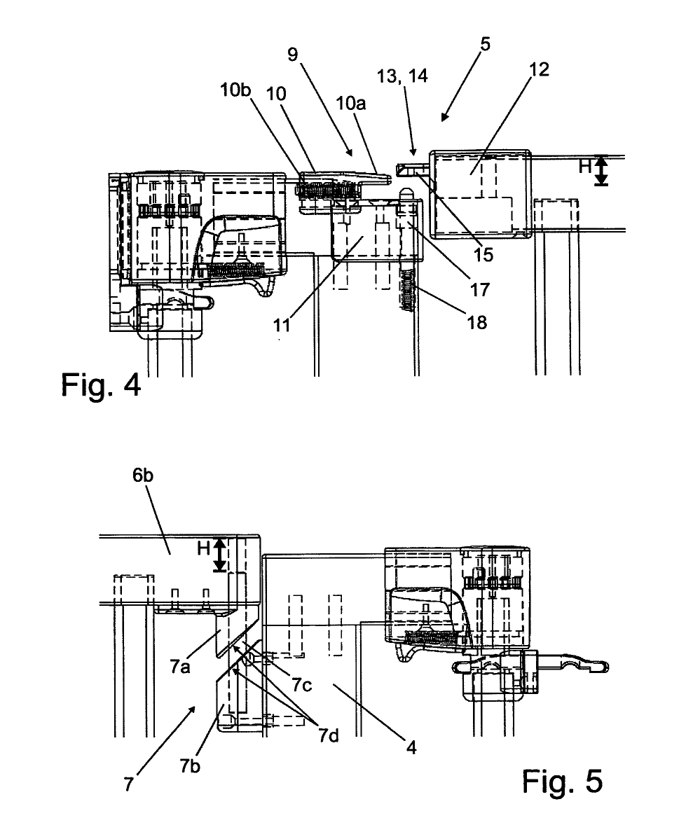

The lock 5 comprises an actuation member 9 being arranged at the upper end of the first side part 3 and hence being arranged stationarily at the frame and not at the pivotable door member 6. The actuation member 9 has a support block 11 being bolted to the presently wooden side part 3, a slide 10 being slidably supported on the support block by means of a guiding groove 10c. The slide 10 is loaded in locking direction by means of a spring 10b which is supported against the side part 3, and can be displaced against the spring force by operation, e.g. with a thumb. The slide 10, in the view of FIG. 3, is movably hortizontally from right to left (see arrow P in FIG. 2), hence parallel to the plane which is stretched out by the frame 1.

The slide 10 comprises a locking bar 10a, which presently is formed as a projection protruding in the direction of the door member 6 uniformly and one-piece with the slide 10.

In the closed position (see FIG. 1), the locking bar 10a overlaps an abutment 12, which is arranged at the door member 6. The abutment 12 is formed as an injection molded plastic part and is bolted and/or glued to the outer end of the wooden crossbar 6b of the door member 6. The abutment 12 has a protruding pointer 13 which has a borehole 14. The pointer 13 further comprises two laterally bevels 15.

Furthermore, a spring loaded catch 16 is provided at the support block 11 and the side part 3, the catch comprising a perpendicularly movable pin 17 and a spring 18, the spring being supported between the pin 17 and the side part 3. The pin 17 has a rounded top protruding above a surface of the support 11 and can be pressed in against the force of the spring 18.

The function of the lock 5 is as follows:

In the locked state (FIG. 1), the slide 10 is shifted towards the side part by an operator, the locking bar 10a no more overlapping the pointer 13. In this state, the pin 17 of the catch 16 still engages the borehole 14 of the pointer and blocks a pivoting of the door member. The engagement of the catch 16 in the borehole (shackle member) 14 hence still provides a positive blockade against pivoting the door member 6 open.

In a second step of the opening procedure, the door member 6 is then lifted about a stroke H, thereby lifting the pointer 13 of the abutment 12 above the pin 17 and/or releasing the positive blockade and the door can be pivoted open. The pivoting of the door member can selectably happen in both directions, as in the completely unlocked and lifted state, it can freely pivot through the frame 1.

In the course of the closing procedure, the slide 10 and the door member 6 are in the base position caused by the resetting forces. The door may be pivoted closed manually or simply by letting loose, being pivoted closed by the resetting hinge 7. In pivoting closed, firstly a respective of the two bevels 15 of the pointer 13 interacts with the rounded top of the pin 17, the pin being pushed downwards. When overlapping with the norehole 14, the pin 17 then snaps into the borehole 14, the borehole 14 forming a shackle member for the catch 16.

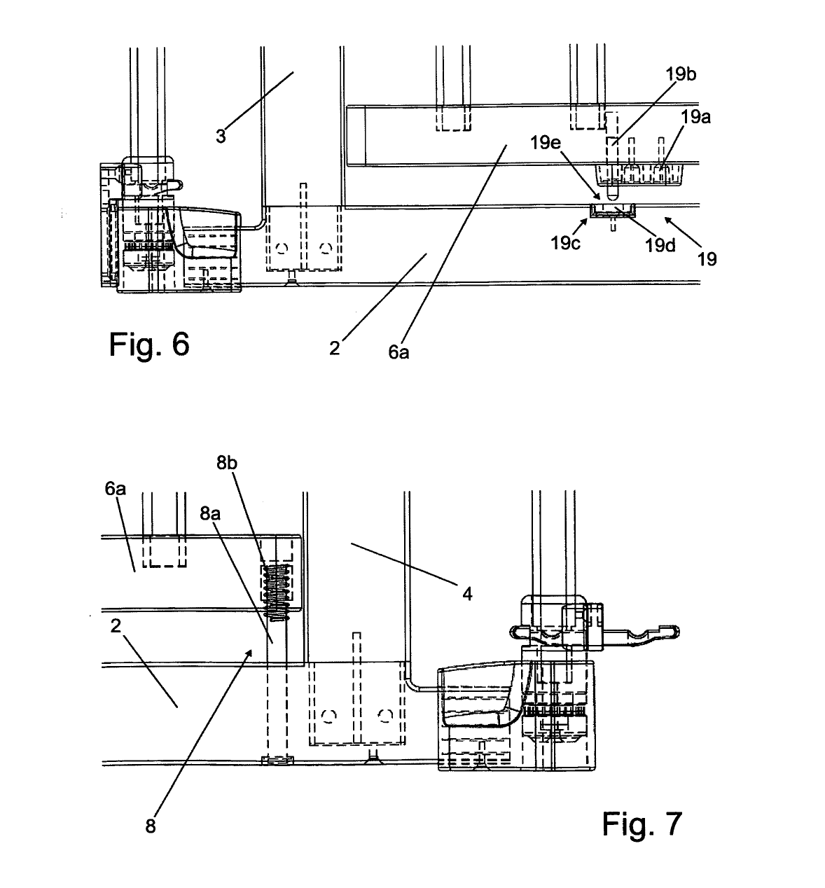

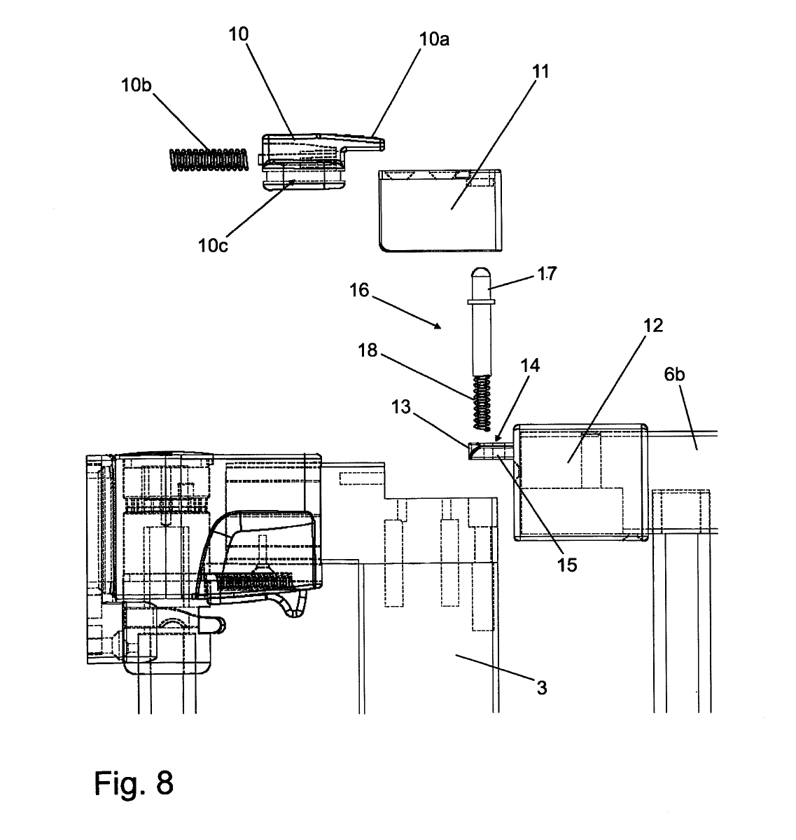

Further to the lock described above, the safety gate has a further lock 19 which is arranged separately from the lock 5 at a bottom side of the door member 6. FIG. 6 shows this lock 19 in a closed state. An upper lock half 19a is bolted to the lower crossbar 6a of the door member 6 and comprises a locking pin 19b protruding perpendicularly downwards, the locking pin being perpendicularly movable like a catch and being loaded by a spring which is not displayed.

In the closed state of the door, the locking pin 19b protrudes into a recess 19e of a counter support 19c bolted to the base 2 of the frame 1. The sidewalls 19d of the counter support are outwardly bevelled, the spring-loaded catch 19b sliding over the bevelled sidewalls in the course of closing the door and being compressed, after which the catch snaps into the recess 19e.

For opening of the door member 6, the further lock 19 is disengaged by lifting of the door member 6 about the previously mentioned stroke H. Therefore, the second lock 19 also provides a positive blockade against pivoting the door member open.

In the case of the present embodiment the lock 19, which is arranged additionally to and separated from the lock 5, presents a measure which is supplementary and stabilizing the locked door, wherein the principal function of the locking is already integrated in the lock 5.

It is generally pointed out that the term “safety gate” in the scope of the present invention not only comprises door members with grid-like structures, as is provided by the door member of the present embodiment with its crossbars 6a, 6b and longitudinal bars, but also comprises solid panels, for instance made of wood, plastics or even acrylic glass.

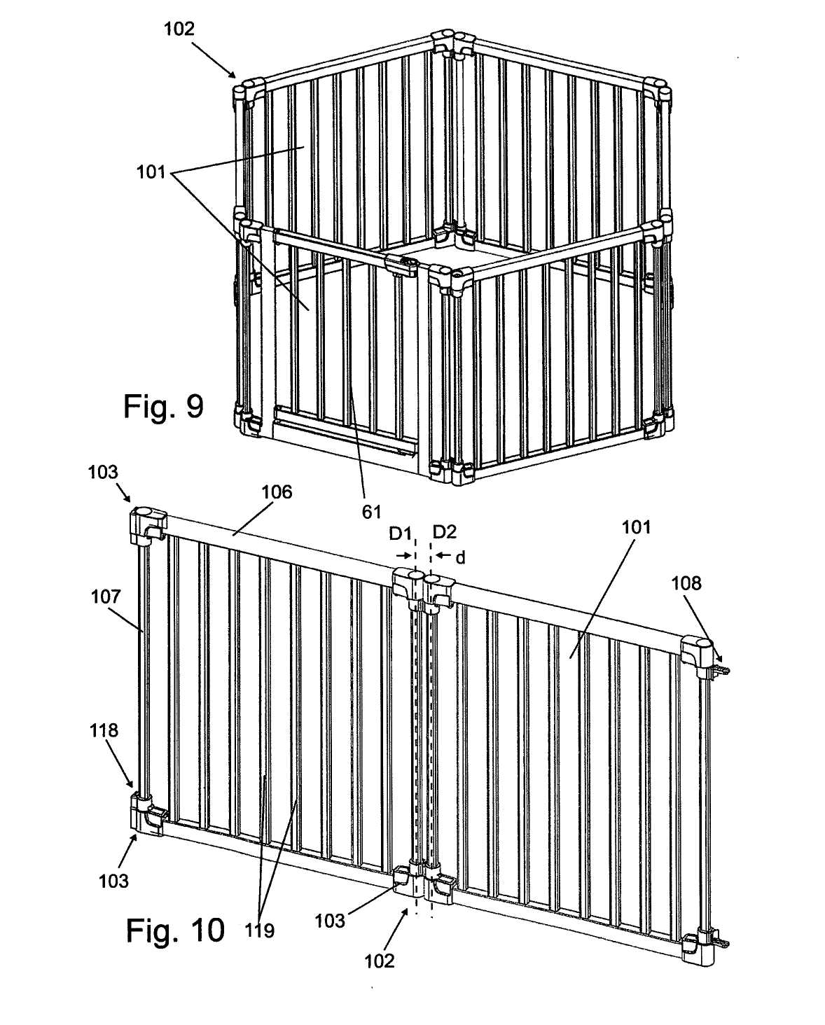

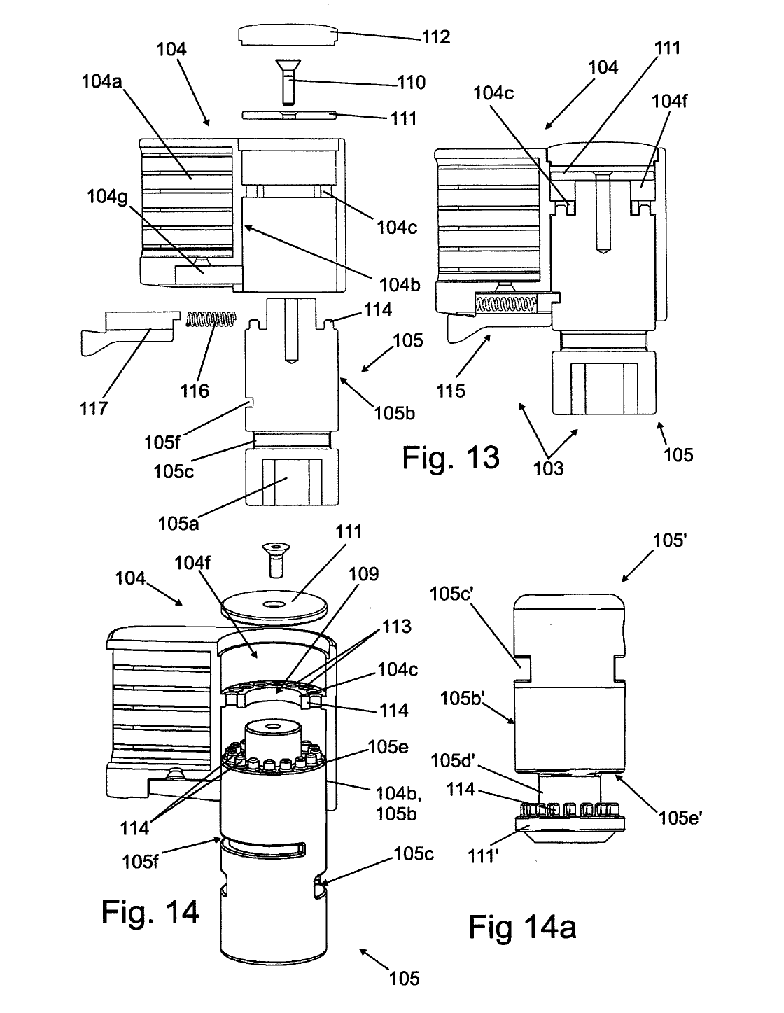

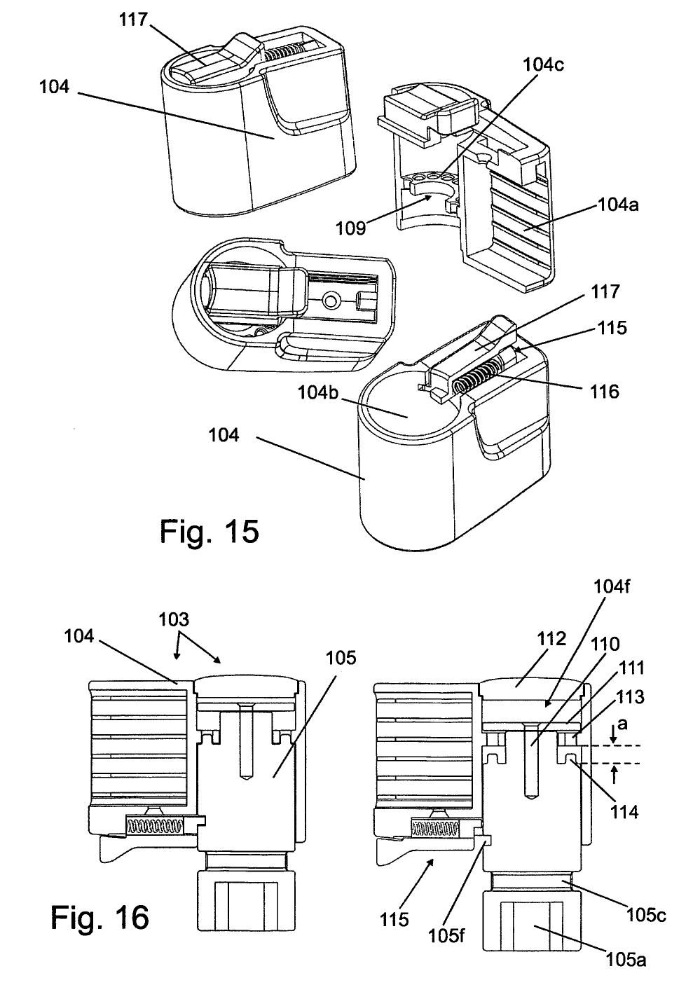

Below, a new kind of barrier is described which preferably is combined with the above described safety gate. The barrier shown in FIG. 9 to FIG. 16 is displayed with a different safety gate (see FIG. 9), which is to be replaced by the safety gate of FIG. 1 in the sense of the preferred embodiment. For this purpose, the protective door described above already comprises the respective articulated connections 102.

The barrier has two or more planar segments 101, an articulated connection 102 being provided between the segments, respectively. In FIG. 9, a barrier with six segments 101 is provided, which are arranged as a closed hexagon in the kind of a playpen for a child. One of the segments is provided as the safety gate described above. In another embodiment, the barrier may as well be provided as a simple playpen or folding barrier without a safety gate.

Each of an articulated connection 102 of two segments 101 has a first pivot axis D1 and a second pivot axis D2 being separated thereof by a distance d. This is designed by respectively providing an upper hinge and a lower hinge 103 at the ends of each of the adjacent segments 101, resulting in respectively two of the hinges 103 being assigned to each one of the pivot axes D1, D2.

Each of the four hinges 103 of the articulated connection 102 has a first hinge part 104 and a second hinge part 105 which in each case are formed as molded plastic parts, in particular as injection-molded parts.

The first hinge part 104 is rigidly connected with the segment 101 by means of inserting an upper or lower crossbar 106 of the segment 101 into a pocket 104a of the hinge part 104 and gluing and/or bolting it there.

The second hinge part 105 is accommodated in the first hinge part 104 rotatably with respect to the segment 101, a cylindrical outer side wall 105b of the second hinge part being guided at an internal cylindrical side wall 104b of the first hinge part.

A strut 107 is accommodated and fixed with each of its ends in respectively one axially oriented pocket 105a of the second hinge parts 105 of a segment 101, for instance by means of adhesive and/or screws.

The strut 107 forms a rigid unit with the two end-sided hinge parts, which unit is rotatable in the first hinge parts 104 and with respect to the segment 101.

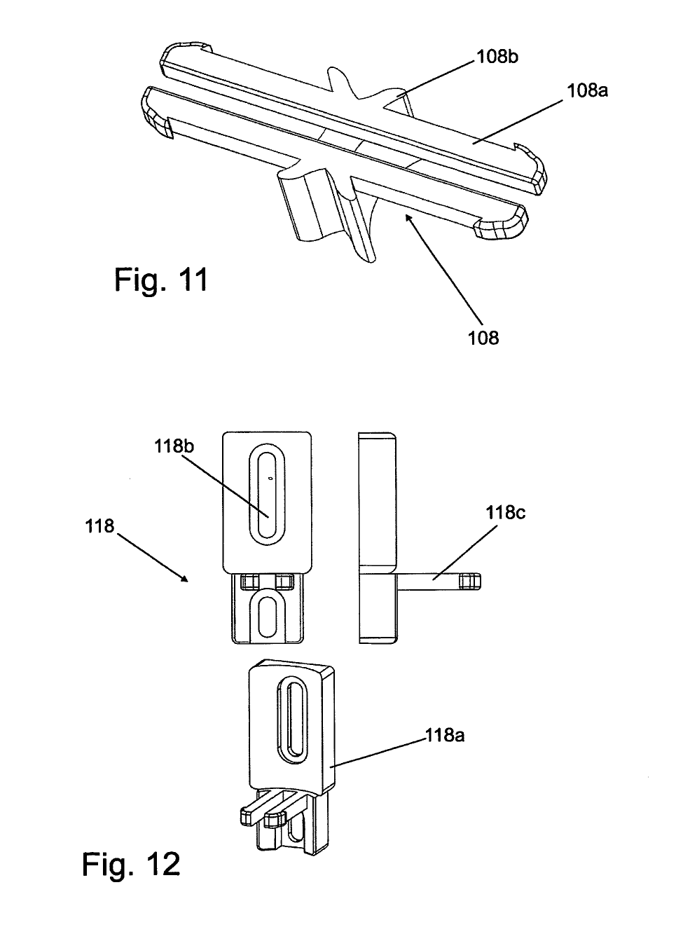

The parallel struts 107, or the rigid units of adjacent segments 101, are interconnected by means of connectors 108 (see FIG. 11). For this purpose, respectively one connector 108 is inserted in a receiver 105c like a clip and positively releasably engaged with pairs of elastic tabs 108a which protrude symmetrically double-sided from a central abutment piece 108b of the connector. The receiver 105c, which is formed as an opening with rectangular cross section, is positioned at a neck section of each of the second hinge parts 105 between the pocket 105a for the strut and the cylindrical wall section 105b which is guided in the first hinge part 104.

The connectors 108 have a central symmetry plane and may be inserted into the hinge parts 105 in two arbitrary orientations, wherein the abutment piece 108b has two concave faces for a supporting contact with the second hinge parts 105, 105′. This further ensures to hold the hinges and hinges axes D1, D2 of the adjacent segments in a defined distance d.

FIG. 12 shows a terminal connector 118 for connecting a terminal segment of the barrier to a wall or similar. The terminal connector 118 has a body 118a with holes 118b for bolting or other fixation e.g. to a wall or a door frame. From the body 118, a pair of elastic tabs 118c, which are identical with the elastic tabs of the connector 108, and which can engage in the receivers 105c, 105c′ of the second hinge parts 105, 105′.

The rotatability of the second hinge part 105 in the first hinge part 104 is releasably lockable in discrete, defined angular orientations, as is further explained by the below detailed description of the hinge parts 104, 105.

The first hinge part 104 has a cylindrical recess with the internal cylindrical side wall 104b, wherein the recess is terminated in the axial direction by a bottom 104c which forms a face of the recess and extends perpendicular to the pivot axis D1, D2. The bottom 104c has a central bore 109 for penetration of a fixing bolt 110 and of a protrusion 105d of the first hinge part 105.

The protrusion 105d protrudes centrally from a face 105e of the second hinge part 105, which face extends parallel to the face 104c of the first hinge part and/or perpendicular to the pivot axis D1, D2.

By means of the bolt 110, a stopper plate 111 is connected to the protrusion 105d in the course of assembly of the hinge, the face 104c being enclosed between the stopper plate 111 and the face 105e of the second hinge part 105.

The assembled unit having the second hinge part 105 and the stopper plate 111 is axially displaceable with respect to the frist hinge part 104 about a stroke a (see FIG. 16), the stopper plate moving within a hollow cylindrical space 104f above the bottom 104c. The hollow cylindrical space 104f is closed by a decorative cap 112 which is not essential for the function of the hinge.

In order to enable the locking of the hinge in descrete angualr position, concentric recesses 113 shaped as circular openings are provided in the bottom 104c of the first hinge part. Axially oriented protrusions 114 of the second hinge part 105 correspond with these recesses. The protrusions 114 are arranged concentric on the face 114f of the second hinge part.

In the present example, the recesses 113 are zylindrical boreholes and the protrusions are zylindrical pins. There are as many protrusions 114 as boreholes 113 present, namely 16, being arranged with respect to each other in the same angular distance of 22.5°. Hence it is achieved that the hinge can be locked in angular distances of 22.5°, wherein a particularly safe and torque-resisting locking is achieved by the large number of recesses and pins positively engaging with each other.

The locking and/or releasing of the two hinge parts 104, 105 is achieved by an axially directed displacement of the second hinge part 105, and/or the unit of the hinge parts 105, 105′ and the strut 107, with respect to the second hinge parts 104.

FIG. 16 demonstrates this by a comparative display of the locked position (right figure) and the released position (left figure) for the case of an upper hinge 104, 105.

In order to secure the axial displacement at least in the locked position and/or to releasably block it there, a blocking member 115 is provided at the hinge parts. The blocking member 115 comprises a latch 117 linearly loaded by a spring 116, which latch is guided in a groove 104g at the first hinge part 104, a front edge of the latch being able to snap into an angular groove 105f of the second hinge part 105. In the snapped-in position (see left of FIG. 16), no axial movement of the hinge parts 104, 105 is possible. For releasing the blocking, the latch 117 has to be shifted against the spring force first, the operator then mutually displacing the hinge parts 104, 105, followed by changing the pivot angle of the segments 101 and finally shifting the hinge parts back again into the locked position (see left of FIG. 16) with the blocking member 115 snapping in.

In the following, differences in the design of the upper hinges and lower hinges are pointed out. The lower hinges are not provided with a blocking member 115, in order not to complicate the operation unnecessarily. Yet only the latch 117 is omitted, wherein the first hinge part 114 is identical for the upper and lower hinges, including the groove 114g.

FIG. 14a shows a slightly modified second hinge part 105′, which is to be used with the lower hinges. It differs from the second hinge part 105 (see e.g. FIG. 14) by the fact that the axial protrusions 114 are not arranged on the face 115e, but at a face of the stopper plate 111′ directed towards the bottom 104c. Thereby, both hinges of a hinge axis D1, D2 can be released or locked simultaneously. In this design of the second hinge part 105′, a second face in the sense of the invention is provided at the stopper plate 111′, other than the second face in the sense of the invention in the upper, second hinge part 105 being the face 105e of the cylindrical section 105b.

It is to be understood that, alternatively to the described examples, the protrusions at the bottom 104c and the corresponding recesses may as well be provided at the second hinge part 105, let it be at the face 105e or at the stopper plate 115.

It is possible within the scope of the invention that just one of the two hinges of a hinge axis is designed lockable, for instance like an upper hinge 104, 105 or like a lower hinge 104, 105′.

In a further embodiment not displayed, the two hinge parts 104, 105, 105′ may be axially spring loaded against each other. In such case, a coil spring may be provided pre-loaded in the hollow cylindrical space 104f, such that the hinge is pressed into the locking position by means of the spring. In such embodiment, the blocking member 115 may eventually be omitted.

The planar segments 101 may be designed as grids, as e.g. shown in FIG. 10, with upper and lower crossbars 106 and grid rods 119 running in-between. Alternatively, the segments may as well comprise closed panels made from wood or plastics, in particular transparent plastics. In particular, one of the planar segments 101 is provided as a safety gate.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A safety gate for children or pets, the safety gate comprising:
a frame that is configured to be stationarily positioned, the frame having a lower base and two side parts extending upwards from the lower base;
a door member hinged to the frame, the door member being pivotable about a pivot axis; and
a lock, the door member and the frame being releasably interconnectable with each other via the lock;
an actuation member, the actuation member being configured for an at least partial releasing of the lock,
wherein the actuation member is arranged stationarily at one of the side parts of the frame,
wherein, between the door member and the frame, a positive blockade against a pivoting of the door member is provided, and
wherein the blockade is releasable by moving the door member about a defined stroke parallel to the pivot axis.

2. The safety gate according to claim 1, wherein, from a closed position, the door member is configured to be pivoted open in two directions.

3. The safety gate according to claim 1, wherein the actuation member comprises a spring loaded slide for opening the lock.

4. The safety gate according to claim 3, wherein the slide is moveable parallel to a plane which is stretched out by the frame.

5. The safety gate according to claim 1, wherein an abutment being arranged at the door member is overlapped by a moveable latch of the actuation member, and wherein a lifting of the door member is blocked by the overlapping of the abutment.

6. The safety gate according to claim 5, wherein the abutment comprises a horizontally protruding pointer.

7. The safety gate according to claim 5, wherein a catch member is arranged at the actuation member or the abutment, wherein the catch member is spring loaded, and wherein a shackle member acting in combination with the catch member is arranged at a respective other of the actuation member or abutment.

8. The safety gate according to claim 1, wherein a second lock is provided between the door member and the frame, and wherein the second lock is arranged at the lower base.

9. The safety gate according to claim 8, wherein the second lock is releasable by moving the door member by a stroke parallel to the pivot axis.

10. The safety gate according to claim 8, wherein, in the course of pivoting the door member into the closed position, the second lock snaps by a spring-loaded catch.

11. The safety gate according to claim 1, wherein the frame is releasably fixed by jamming or bolting between stationary structures or door frames or banisters.

12. The safety gate according to claim 1, wherein the safety gate provides one out of a plurality of segments of a foldable barrier.

13. The safety gate according to claim 12, wherein, in each case, an articulated connection is provided between the segments, which connection being releasably fixable in a positive controlled manner in multiple, discrete angular positions.
